(19) United States
(12) Patent Application Publication
(10) Pub. No.: US 2013/0167805 A1
(43) Pub. Date: Jul. 4, 2013

(54) FUEL SUPPLY STRUCTURE

(71) Applicant: KAWASAKI JUKOGYO KABUSHIKI KAISHA, HYOGO (JP)

(72) Inventors: Masaya OTSUKA, Kakogawa-shi (JP); Mitsuru MATSUSHITA, Kako-gun (JP)

(73) Assignee: KAWASAKI JUKOGYO KABUSHIKI KAISHA, HYOGO (JP)

(21) Appl. No.: 13/721,679

(22) Filed: Dec. 20, 2012

(30) Foreign Application Priority Data
Dec. 28, 2011 (JP) 2011-289164

(51) Int. Cl. F02M 39/02

(52) U.S. Cl. CPC F02M 39/02
USPC 123/468

(57) ABSTRACT

A fuel supply structure which can prevent significant decrease in fuel pressure to make the return of the fuel pressure to a steady value faster is provided. In a fuel supply structure which has a fuel pump 21 sucking fuel in a fuel tank 12 and supplying the fuel into a fuel supply section of an engine 14, and a fuel hose 30 connecting the fuel supply section and the fuel pump 21, the fuel supply section includes a plurality of fuel supply sections, the fuel hose 30 has a shared hose section 31 provided on the fuel supply upstream side, and a plurality of individual hose sections 32 and 33 provided on the fuel supply downstream side and branched from the shared hose section 31, and at least a portion of at least any one of the shared hose section 31 and the individual hose sections 32 and 33 is made of an elastic body.

### TECHNICAL FIELD

The present invention relates to a fuel supply structure which has a fuel pump supplying fuel into a fuel supply section of an engine, and a fuel hose connecting the fuel supply section and the fuel pump.

### BACKGROUND ART

For instance, as disclosed in Patent Literature 1, there is a fuel supply structure of a motorcycle having a plurality of fuel supply sections.

### CITATION LIST

### Patent Literature

[PTL 1] Japanese Patent Application Laid-Open No. 2008-185018

### SUMMARY OF INVENTION

### Technical Problem

When the fuel supply sections are set to the same fuel supply timing in the case of a plurality of the fuel supply sections, fuel pressure is significantly decreased. After fuel supply at a certain fuel supply timing, at the next fuel supply timing, the fuel pressure cannot return to a steady value. Due to this, the fuel supply sections are set to different fuel supply timings to prevent significant decrease in fuel pressure. In consideration of the margin of the fuel supply timing setting, originally, significant decrease in fuel pressure can be preferably prevented so as not to deteriorate the return of the fuel pressure to the steady value even when the fuel supply sections are set to the same fuel supply timing.

Accordingly, an object of the present invention is to provide a fuel supply structure which has a plurality of fuel supply sections and can prevent significant decrease in fuel pressure to make the return of the fuel pressure to a steady value faster even when fuel is supplied into the fuel supply sections at the same timing.

### Solution to Problem

The present invention provides a fuel supply structure which has a fuel pump sucking fuel in a fuel tank and supplying the fuel into a fuel supply section of an engine, and a fuel hose connecting the fuel supply section and the fuel pump, wherein the fuel supply section includes a plurality of fuel supply sections, the fuel hose has a shared hose section provided on the fuel supply upstream side, and a plurality of individual hose sections provided on the fuel supply downstream side and branched from the shared hose section, and at least a portion of at least any one of the shared hose section and the individual hose sections is made of an elastic body.

According to the configuration, at least a portion of the fuel hose is made of an elastic body. Therefore, the change in fuel pressure at the time of fuel supply can be prevented by the elastic body. As a result, significant decrease in fuel pressure at the time of fuel supply can be prevented to make the return of the fuel pressure to a steady value faster.

The present invention preferably further has the following configurations.

(1) The plurality of the individual hose sections includes an individual extended hose section extending from the fuel supply downstream end of the shared hose section in the extension direction of the fuel supply direction, and an individual branched hose section extending from the fuel supply downstream end of the shared hose section in the direction different from the extension direction, and at least a portion of at least any one of the individual branched hose sections is made of an elastic body.

(2) Among the individual hose sections, at least a portion of the individual hose section having the smallest fuel supply amount is made of an elastic body.

(3) The hose section made of an elastic body or a portion thereof is disposed substantially straightly.

(4) The hose section made of an elastic body or the hose section with the elastic body portion is formed to have a larger inside diameter than the hose section without the elastic body portion.

(5) In the entire fuel hose, the hose section not made of an elastic body and any non-elastic body portion of the hose section with the elastic body portion are made of a resin.

According to configuration (1), at least a portion of at least any one of the individual branched hose sections which have greater change in fuel pressure than the shared hose section is made of an elastic body. Therefore, the change in fuel pressure at the time of fuel supply can be prevented more effectively.

According to configuration (2), the fuel in a relatively large amount remains in the individual hose section having the smallest fuel supply amount after fuel supply. By pushing out the remaining fuel by the elastic body, the fuel can be delivered to the individual hose section having a large fuel supply amount. As a result, the fuel can be flexibly supplied between the individual hose sections by the time of fuel supply from the fuel pump. Therefore, the change in fuel pressure at the time of fuel supply can be prevented more effectively.

According to configuration (3), the hose section made of an elastic body or a portion thereof is substantially straight. Therefore, the change in fuel pressure at the time of fuel supply can be prevented more effectively. In addition, the hose section or a portion thereof is substantially straight. Therefore, the portion can be easily formed of an elastic body.

According to configuration (4), the hose section with the elastic body portion has a larger inside diameter than the hose section without the elastic body portion. Therefore, the change in fuel pressure at the time of fuel supply can be easily absorbed, so that the change in fuel pressure at the time of fuel supply can be prevented more effectively.

According to configuration (5), any non-elastic body portion of the fuel hose is made of a resin. Therefore, the strength of the fuel hose can be easily ensured.

### Advantageous Effects of Invention

In brief, according to the present invention, the fuel supply structure which can prevent significant decrease in fuel pressure at the time of fuel supply to make the return of the fuel pressure to a steady value faster can be provided.

### BRIEF DESCRIPTION OF DRAWINGS

FIG. 1 is a left side view of a motorcycle according to an embodiment of the present invention.

FIG. 2 is a perspective view of a fuel supply structure of the motorcycle of FIG. 1.

FIG. 3 is a graph showing the change in fuel pressure when the entire fuel hose is made of a resin.

FIG. 4 is a graph showing the change in fuel pressure when the entire fuel hose is made of an elastic body.

FIG. 5 is a graph showing the change in fuel pressure when an individual branched hose section is made of an elastic body.

### DESCRIPTION OF EMBODIMENTS

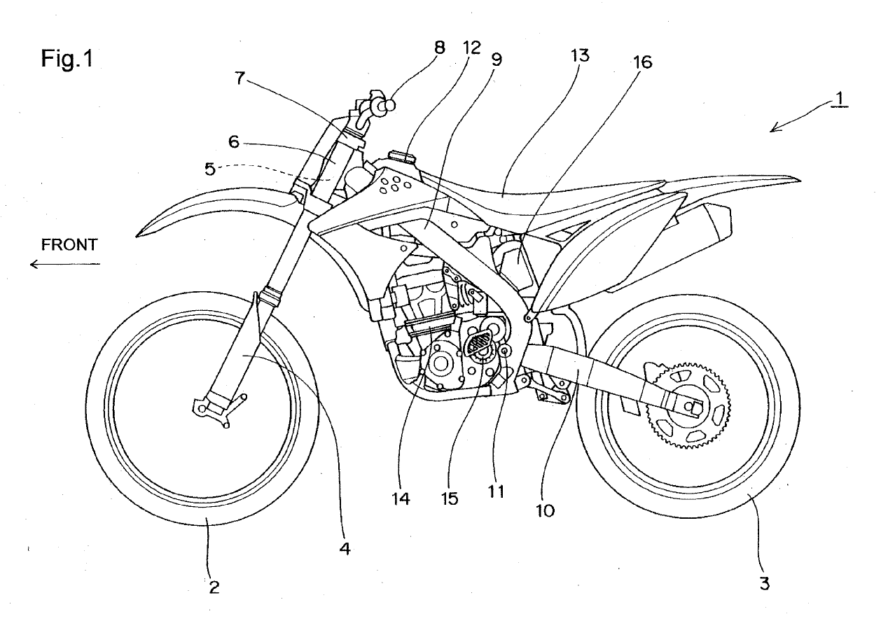

FIG. 1 is a left side view of a motorcycle 1 according to an embodiment of the present invention. Further, the concept of the directions used in this embodiment coincides with the concept of the directions seen from the driver of the motorcycle 1.

As shown in FIG. 1, the motorcycle 1 has a front wheel 2, and a rear wheel 3. The front wheel 2 is rotatably supported in the lower portion of a front fork 4 extending in the substantially up-down direction. The front fork 4 is supported by a steering shaft 5. The steering shaft 5 is rotatably supported by a head pipe 6. The front fork 4 has an upper end at which an upper bracket 7 is provided. To the upper bracket 7, a bar type steering handle 8 extending in the right-left direction is attached. The driver swings the steering handle 8 in the right-left direction, so that the front wheel 2 is steered, with the steering shaft 5 as a rotational shaft.

A body frame 9 extends rearward from the head pipe 6. At the rear lower end of the body frame 9, a swing arm 10 has a front end axially supported by a pivot bolt 11. The swing arm 10 has a rear end rotatably supporting the rear wheel 3. Above the body frame 9 and behind the steering handle 8, a fuel tank 12 is arranged. Behind the fuel tank 12, a driver's seat 13 is arranged. Below the fuel tank 12, an engine 14 is mounted. Behind the engine 14, an output sprocket 15 is arranged. The power of the output sprocket 15 is transmitted to the rear wheel 3.

Below the seat 13 and behind the engine 14, an air cleaner 16 cleaning air supplied to the engine 14 is arranged. The air cleaner 16 cleans air introduced from the front of the vehicle body by means of a cleaner element (not shown) arranged therein, and then delivers the cleaned air to the engine 14.

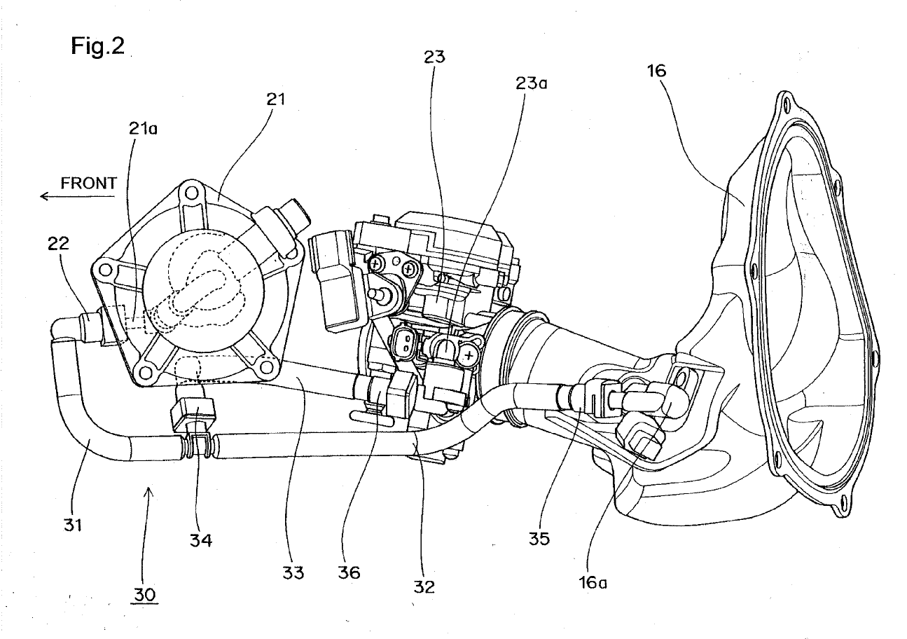

FIG. 2 is a perspective view of a fuel supply structure of the motorcycle 1 of FIG. 1. Inside or outside the fuel tank 12, a fuel pump 21 is provided. The fuel pump 21 has a discharge section 21a to which a pump side connector 22 is attached. To the pump side connector 22, one end of a fuel hose 30 is connected.

The fuel hose 30 has a shared hose section 31 provided on the fuel supply upstream side, and a plurality of individual hose sections 32 and 33 provided on the fuel supply downstream side and branched from the shared hose section 31. The individual hose section 32 includes an individual extended hose section 32 extending from the fuel supply downstream end of the shared hose section 31 in the extension direction of the fuel supply direction. The individual hose section 33 includes an individual branched hose section 33 extending from the fuel supply downstream end of the shared hose section 31 in the direction different from the extension direction of the fuel supply direction.

The fuel supply upstream end of the shared hose section 31 is connected to the pump side connector 22. The fuel supply downstream end of the shared hose section 31 is connected to a branching connector 34. The branching connector 34 branches fuel supplied from the shared hose section 31. The fuel supply upstream ends of the individual extended hose section 32 and the individual branched hose section 33 are connected to the branching connector 34. The fuel supply downstream end of the individual extended hose section 32 is connected via a supply side connector 35 to an injector 16a of the air cleaner 16. In addition, the fuel supply downstream end of the individual branched hose section 33 is connected via a supply side connector 36 to an injector 23a of a throttle body 23 of the engine 14.

With the configuration, the fuel in the fuel tank 12 is pressurized by the fuel pump 21, and then passes through the shared hose section 31. Next, the fuel which has passed through the shared hose section 31 is branched into two by the branching connector 34. One of the branched fuels is supplied through the individual extended hose section 32 into the injector 16a of the air cleaner 16. In addition, the other branched fuel is supplied through the individual branched hose section 33 into the injector 23a of the throttle body 23. Therefore, in this embodiment, the fuel supply section is provided in the two portions, the air cleaner 16 and the throttle body 23.

### Comparative Example 1

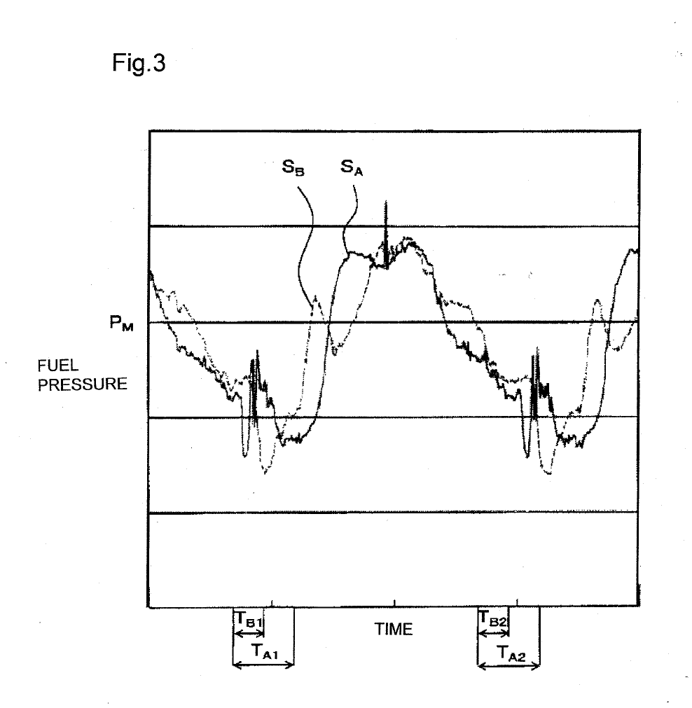

FIG. 3 is a graph showing the change in fuel pressure with time when the entire fuel hose 30 is made of a resin. The graph shows a horizontal axis representing time and a vertical axis representing fuel pressure. The change in fuel pressure in the individual extended hose section 32 is indicated by solid curve S_{A}. The change in fuel pressure in the individual branched hose section 33 is indicated by dashed curve S_{B}. The fuel injection timings of the injector 16a are indicated by T_{A1} and T_{A2}. The fuel injection timings of the injector 23a are indicated by T_{B1} and T_{B2}. Here, the fuel injection conditions are as follows. First, the engine 14 has a rotating speed of 12000 rpm, the injector 16a of the air cleaner 16 has a fuel injection amount percentage of 75%, and the injector 23a of the throttle body 23 has a fuel injection amount percentage of 25%. In addition, fuel injection timings (T_{B1}, T_{B2}) of the injector 23a are set to be overlapped with the first half portion of fuel injection timings (T_{A1}, T_{A2}) of the injector 16a. One injection time (T_{A1} or T_{A2}) of the injector 16a is about 0.006 S. One injection time (T_{B1} or T_{B2}) of the injector 23a is about half of one injection time of the injector 16a, and is about 0.003 S.

As shown in FIG. 3, the fuel pressure is decreased by first fuel injection (T_{A1}, T_{B1}) and is then increased by fuel supply from the fuel pump 21. However, since decrease in fuel pressure by first fuel injection (T_{A1}, T_{B1}) is significant, it takes time for the fuel pressure to achieve required pressure value (P_{M}) of the injector. In addition, at the time of fuel supply from the fuel pump 21, a regulator (not shown) provided in the fuel supply structure controls the fuel pressure in a manner to be increased to a pressure which greatly exceeds required pressure value (P_{M}) of the injector. As a result, the regulator further controls the fuel pressure in a manner to be decreased in order to bring the fuel pressure which has exceeded required pressure value (P_{M}) of the injector close to required pressure value (P_{M}) of the injector. Consequently, in a state where the fuel pressure is below required pressure value (P_{M}) of the injector, second fuel injection (T_{A2}, T_{B2}) is performed. That is, decrease in fuel pressure at the time of fuel supply is significant to slow the return of the fuel pressure to required pressure value (P_{M}) of the injector. As a result, the regulator cannot control the fuel pressure well, so that in a state where the fuel pressure has not achieved required pressure value (P_{M}) of the injector, the fuel injection is performed.

### Example 1

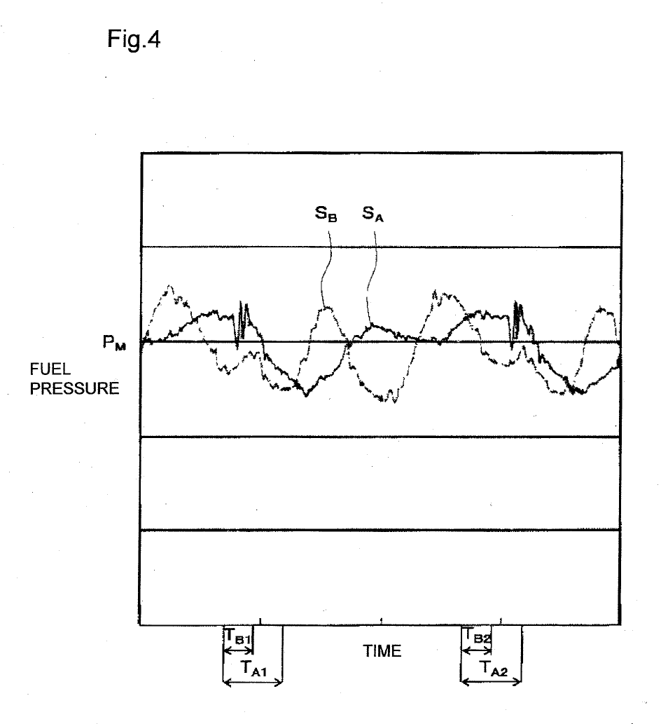

FIG. 4 is a graph showing the change in fuel pressure with time when the entire fuel hose 30 is made of an elastic body (rubber). The graph shows a horizontal axis representing time and a vertical axis representing fuel pressure. The change in fuel pressure in the individual extended hose section 32 is indicated by solid curve S_{A}. The change in fuel pressure in the individual branched hose section 33 is indicated by dashed curve S_{B}. The fuel supply structure and the fuel injection conditions in FIG. 4 are the same as those in FIG. 3 except that the entire fuel hose 30 is made of an elastic body.

As shown in FIG. 4, the entire fuel hose 30 is made of an elastic body, so that the change in fuel pressure is smaller. As a result, at the fuel injection timings (at the time of first fuel injection (T_{A1}, T_{B1}) and at the time of second fuel injection (T_{A2}, T_{B2})), in a state where the fuel pressure is near required pressure value (P_{M}) of the injector, the fuel injection is performed.

### Example 2

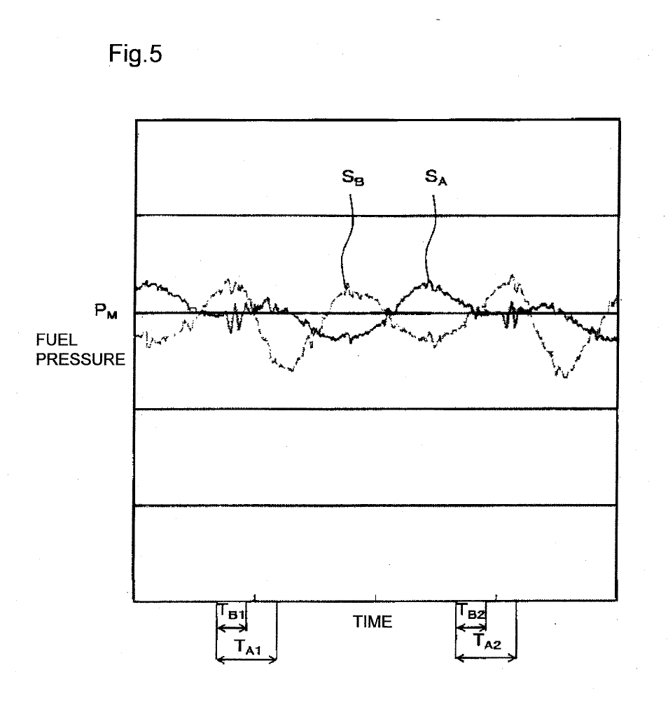

FIG. 5 is a graph showing the change in fuel pressure with time when the individual branched hose section 33 is made of an elastic body (rubber). The graph shows a horizontal axis representing time and a vertical axis representing fuel pressure. The change in fuel pressure in the individual extended hose section 32 is indicated by curve S_{A}. The change in fuel pressure in the individual branched hose section 33 is indicated by curve S_{B}. The fuel supply structure and the fuel injection conditions in FIG. 5 are the same as those in FIG. 3 except that the individual branched hose section 33 is made of an elastic body. Further, the shared hose section 31 and the individual extended hose section 32 are made of a resin.

As shown in FIG. 5, the individual branched hose section 33 is made of an elastic body, so that the change in fuel pressure is smaller. As a result, at the fuel injection timings (at the time of first fuel injection (T_{A1}, T_{B2}) and at the time of second fuel injection (T_{A2}, T_{B2})), in a state where the fuel pressure is near required pressure value (P_{M}) of the injector, the fuel injection is performed.

As described above, the entire individual branched hose section 33 or the entire fuel hose 30 is made of an elastic body, so that the change in fuel pressure at the time of fuel supply (at the time of fuel injection) can be prevented by the elastic body. As a result, decrease in fuel pressure at the time of fuel supply can be prevented to make the return of the fuel pressure to required pressure value (P_{M}) of the injector faster. In a state where the fuel pressure is near required pressure value (P_{M}) of the injector, the fuel injection can be performed.

According to the fuel supply structure of the configurations, the following effects can be exhibited.

(1) At least a portion (in this embodiment, the individual branched hose section 33) of the fuel hose 30 is made of an elastic body. Therefore, the change in fuel pressure at the time of fuel supply can be prevented by the elastic body. As a result, decrease in fuel pressure at the time of fuel supply can be prevented to make the return of the fuel pressure to the steady value (required pressure value (P_{M}) of the injector) faster. Further, in the case of a plurality of the fuel supply sections (in this embodiment, the air cleaner 16 and the throttle body 23), the fuel supply sections can be set to the same fuel supply timing (the same fuel injection timing). Therefore, the margin of the fuel supply timing setting in the fuel supply sections can be increased.

(2) The individual branched hose section 33 having greater change in fuel pressure than the shared hose section 31 is made of an elastic body. Therefore, the change in fuel pressure at the time of fuel supply can be prevented more effectively. Further, the individual extended hose section 32 connected via the supply side connector 35 to the injector 16a also has greater change in fuel pressure than the shared hose section 31. Therefore, like the individual branched hose section 33, the individual extended hose section 32 is made of an elastic body, so that the change in fuel pressure at the time of fuel supply can be prevented more effectively.

(3) The individual branched hose section 33 having a smaller fuel supply amount than the individual extended hose section 32 is made of an elastic body. The elastic body of the individual branched hose section 33 which has a relatively large remaining fuel amount after fuel supply can deliver the remaining fuel therein to the individual extended hose section 32 having a large fuel supply amount (or having a smaller remaining fuel amount than the individual branched hose section 33). As a result, the fuel can be flexibly supplied between the individual hose sections by the time of fuel supply from the fuel pump 21. Therefore, the change in fuel pressure at the time of fuel supply can be prevented more effectively. Further, from the above reason, the individual hose sections 32 and 33 are made of an elastic body more preferably than the shared hose section 31.

(4) Rather than being curved, the elastic body portion is straight, which can easily contract and expand the hose throughout the periphery thereof. Therefore, the individual branched hose section 33 as an elastic body is substantially straight, so that the change in fuel pressure at the time of fuel supply can be prevented more effectively. In addition, a portion (individual branched hose section 33) of the fuel hose 30 is substantially straight. Therefore, the hose section can be easily formed of an elastic body, so that the hose section as an elastic body can be easily attached. Further, the hose section 33 as an elastic body which is substantially straight can reduce the manufacturing cost thereof as compared with when curved.

(5) Any non-elastic body portion (in this embodiment, the shared hose section 31 and the individual extended hose section 32) of the entire fuel hose 30 is made of a resin. Therefore, the strength of the fuel hose 30 can be easily ensured, and the curved shaping can cope with the arrangement of the complicated fuel hose 30 onto the vehicle body.

### Other Embodiments

In the above embodiment, the entire fuel hose 30 or the entire individual branched hose section 33 is made of an elastic body. However, at least a portion of at least any one of the shared hose section 31 and the individual hose sections 32 and 33 should be made of an elastic body. A portion of the hose section is made of an elastic body, so that the change in fuel pressure at the time of fuel supply can be prevented by the elastic body. As a result, decrease in fuel pressure at the time of fuel supply can be prevented to make the return of the fuel pressure to the steady value faster.

In addition, the hose section made of an elastic body or the hose section with the elastic body portion is preferably formed to have a larger inside diameter than the hose section without the elastic body portion. With the configuration, the change in fuel pressure at the time of fuel supply in the elastic body portion can be easily absorbed, so that the change in fuel pressure at the time of fuel supply can be prevented more effectively.

Further, the length of the elastic body portion is appropriately adjusted, so that the change in fuel pressure at the time of fuel supply can be adjusted. The change in fuel pressure at the time of fuel supply can be prevented more effectively according to the engine characteristic.

In the above embodiment, the fuel supply structure of a motorcycle has been taken as an example, but the present invention is not limited to the fuel supply structure of a motorcycle and is applicable to a fuel supply structure of a vehicle having an engine.

Various modifications and changes can also be made without departing from the spirit and scope of the present invention described in the claims.

### INDUSTRIAL APPLICABILITY

The fuel supply structure of the present invention can prevent significant decrease in fuel pressure at the time of fuel supply to make the return of the fuel pressure to the steady value faster. Therefore, the industrial utilization value is great.

### REFERENCE SIGNS LIST

1 Motorcycle
2 Front wheel
3 Rear wheel
4 Front fork
5 Steering shaft
6 Head pipe
7 Upper bracket
8 Steering handle
9 Body frame
10 Swing arm
11 Pivot bolt
12 Fuel tank
13 Seat
14 Engine
15 Output sprocket
16 Air cleaner
21 Fuel pump
22 Pump side connector
23 Throttle body
30 Fuel hose
31 Shared hose section
32 Individual extended hose section
33 Individual branched hose section
34 Branching connector
35 Supply side connector
36 Supply side connector

1. A fuel supply structure which has a fuel pump sucking fuel in a fuel tank and supplying the fuel into a fuel supply section of an engine, and a fuel hose connecting the fuel supply section and the fuel pump,
wherein the fuel supply section includes a plurality of fuel supply sections,
the fuel hose has a shared hose section provided on the fuel supply upstream side, and a plurality of individual hose sections provided on the fuel supply downstream side and branched from the shared hose section, and
at least a portion of at least any one of the shared hose section and the individual hose sections is made of an elastic body.

2. The fuel supply structure according to claim 1,
wherein the plurality of the individual hose sections includes an individual extended hose section extending from the fuel supply downstream end of the shared hose section in the extension direction of the fuel supply direction, and an individual branched hose section extending from the fuel supply downstream end of the shared hose section in the direction different from the extension direction,
wherein at least a portion of at least any one of the individual branched hose sections is made of an elastic body.

3. The fuel supply structure according to claim 1, wherein among the individual hose sections, at least a portion of the individual hose section having the smallest fuel supply amount is made of an elastic body.

4. The fuel supply structure according to claim 1, wherein the hose section made of an elastic body or a portion thereof is disposed substantially straightly.

5. The fuel supply structure according to claim 1, wherein the hose section made of an elastic body or the hose section with the elastic body portion is formed to have a larger inside diameter than the hose section without the elastic body portion.

6. The fuel supply structure according to claim 1, wherein in the entire fuel hose, the hose section not made of an elastic body and any non-elastic body portion of the hose section with the elastic body portion are made of a resin.
